(19) United States
(12) Patent Application Publication
(10) Pub. No.: US 2023/0357563 A1
(43) Pub. Date: Nov. 9, 2023

(54) POLYESTER COMPOSITIONS AND CORRESPONDING ARTICLES

(71) Applicant: SOLVAY SPECIALTY POLYMERS USA, LLC, Alpharetta, GA (US)

(72) Inventors: Chinomso NWOSU, Alpharetta, GA (US); Vijay GOPALAKRISHNAN, Dunwoody, GA (US); Raleigh L. DAVIS, Suwanee, GA (US)

(21) Appl. No.: 17/802,177

(22) PCT Filed: Feb. 25, 2021
(86) PCT No.: PCT/EP2021/054701

§ 371 Date: Aug. 25, 2022

Related U.S. Application Data
(60) Provisional application No. 62/986,837, filed on Mar. 9, 2020.

(30) Foreign Application Priority Data
Jun. 8, 2020 (EP) 20178769.4

(51) Int. Cl. C08L 67/02

(52) U.S. Cl. CPC C08L 67/02; C08L 2205/025

(57) ABSTRACT

Described herein are polyester compositions including a semi-aromatic, semi-crystalline polyester, a polyolefin and a glass fiber having a low Dₖ and low D_{f} (“low Dₖ/D_{f} glass fiber”). The concentrations of the semi-crystalline polyester and polyolefin are selected such that the polyester weight ratio is from 70% to 95%. It was surprisingly found that when the polyester weight ratio was in the aforementioned range, the polyester compositions had an excellent balance of dielectric properties (Dₖ and D_{f}) and mechanical properties (e.g., notched impact strength). It was also surprisingly found that when polyester composition further included high Dₖ/D_{f} glass fibers, the balance of dielectric and mechanical properties was still further improved when the polyester weight ratio was from 75% to 93%. Due at least in part to the excellent balance of dielectric and mechanical properties, the polyester compositions can be desirably incorporated into mobile electronic device components.

### CROSS REFERENCE TO RELATED APPLICATIONS

This application claims priority to U.S. provisional patent application No. 62/986837, filed on Mar. 9, 2020, and European patent application No. 20178769.4, filed on Jun. 8, 2020, the whole content of each of these applications being incorporated herein by reference for all purposes.

### FIELD OF THE INVENTION

The invention relates to polyester compositions, including a semi-aromatic, semi-crystalline polyester, a polyolefin and a low Dₖ/D_{f} glass fiber and having an excellent balance of dielectric properties and mechanical properties. The invention also relates to articles, such as mobile electronic device components, incorporating the polyester compositions.

### BACKGROUND OF THE INVENTION

With the rapid proliferation of 5G communications, there is a continual need for polymeric materials that can be desirably incorporated into applications settings including mobile electronic device components. More particularly, mobile electronic devices require a good balance of mechanical strength and dielectric performance. With respect to the former, mobile electronic devices are routinely subjected to drops and bumps and exposed to large temperature changes during use. Therefore, the incorporated polymeric materials must have good mechanical performance. At the same time, the polymeric material must have good dielectric performance (low Dₖ and D_{f}) so that the material does not undesirably interfere with 5G communications to and from the mobile electronic device.

### SUMMARY OF INVENTION

In one aspect, the invention relates to a polyester composition including: a semi-aromatic, semi-crystalline polyester; a polyolefin comprising a recurring unit (R_{PO}) including at least 50 mol % of a recurring unit (R_{PO}) including at least 4 carbons, preferably at least 5 carbons, the mol % being relative to the total number of recurring units in the polyolefin, the recurring unit (R_{PO}) being represented by the following formula:

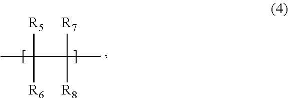

where R₅ to R₈ are independently selected from the group consisting of a hydrogen and a C₁-C₁₀ alkyl group. The polyester composition further includes a glass fiber having, as measured according to ASTM D150 at 1 MHz, a Dₖ of no more than 5.5 and a D_{f} of no more than 0.002, and a polyester weight ratio of from 70% to 95%. The polyester weight ratio is given by the formula:

$$100 \times \frac{{W}_{PE}}{{W}_{PO} + {W}_{PE}} ,$$

where W_{PE} and W_{PO} are, respectively, the weight of the semi-aromatic, semi-crystalline polyester and the polyolefin in the polyester composition.

In some embodiments, the semi-aromatic, semi-crystalline polyester is selected from the group consisting of polycyclohexylenedimethylene terephthalate (“PCT”), polyethylene terephthalate (“PET”), polybutylene terephthalate (“PBT”), polyethylene naphthalate (“PEN”) and polybutylene naphthalate (“PBN”). Additionally or alternatively, in some embodiments, the polyolefin is selected from the group consisting of poly(4-methyl-1-pentene), poly(1-butene), poly(1-pentene) and poly(1-hexene); preferably, the polyolefin is poly(4-methyl-1-pentene).

In some embodiments, the polyester composition further includes a high Dₖ/D_{f} glass fiber. Additionally or alternatively, in some embodiments, the polyester weight ratio is from 75% to 93%.

In some embodiments, the polyester composition comprises, as measured according to ASTM D150 at 1 kHz, a Dₖ of no more than 3.5 and a D_{f} of no more than 0.003. Additionally or alternatively, in some embodiments, the polyester composition comprises, as measured according to ASTM D150 at 1 MHz, a Dₖ of no more than 3.4 and a D_{f} of no more than 0.03.

In some embodiments, the polyester composition comprises a notched impact strength of at least 80 J/m, as measured according to ASTM D256.

In another aspect the invention is directed to a mobile electronic device component comprising the polyester composition.

### BRIEF DESCRIPTION OF THE DRAWING

FIG. 1 is a graph showing plots of normalized notched-impact strength as a function of PE weight ratio for a (A) polyester composition free of glass fibers, (B) a polyester composition including low Dₖ/D_{f} glass fibers as the only glass fibers and (C) a polyester composition including a blend of low Dₖ/D_{f} glass fibers and high Dₖ/D_{f} glass fibers.

### DETAILED DESCRIPTION OF THE INVENTION

Described herein are polyester compositions including a semi-aromatic, semi-crystalline polyester, a polyolefin and a glass fiber having a low dielectric constant (“Dₖ”) and low dissipation factor (“D_{f}”) (“low Dₖ/D_{f} glass fiber”). The concentrations of the semi-crystalline polyester and polyolefin are selected such that the polyester weight ratio (weight of polyester in the composition relative to the total weight of the polyester and polyolefin in the composition) is from 70% to 95%. It was surprisingly found that when the polyester weight ratio was in the aforementioned range, the polyester compositions had an excellent balance of dielectric properties (Dₖ and D_{f}) and mechanical properties (e.g., notched impact strength). It was also surprisingly found that when polyester composition further included high Dₖ/D_{f} glass fibers, the balance of dielectric and mechanical properties was still further improved when the polyester weight ratio was from 75% to 93%. Due at least in part to the excellent balance of dielectric and mechanical properties, the polyester compositions can be desirably incorporated into mobile electronic device components.

Unless specifically limited otherwise, the term “alkyl”, as well as derivative terms such as “alkoxy”, “acyl” and “alkylthio”, as used herein, include within their scope linear chain, branched chain and cyclic moieties. Examples of alkyl groups are methyl, ethyl, 1-methylethyl, propyl, 1,1-dimethylethyl, and cyclo-propyl. Unless specifically stated otherwise, each alkyl and aryl group may be unsubstituted or substituted with one or more substituents selected from but not limited to halogen, hydroxy, sulfo, C₁-C₆ alkoxy, C₁-C₆ alkylthio, C₁-C₆ acyl, formyl, cyano, C₆₋C₁₅ aryloxy or C₆-C₁₅ aryl, provided that the substituents are sterically compatible and the rules of chemical bonding and strain energy are satisfied. The term “halogen” or “halo” includes fluorine, chlorine, bromine and iodine, with fluorine being preferred.

The term “aryl” refers to a phenyl, indanyl or naphthyl group. The aryl group may comprise one or more alkyl groups, and are called sometimes in this case “alkylaryl”; for example may be composed of an aromatic group and two C₁-C₆ groups (e.g., methyl or ethyl). The aryl group may also comprise one or more heteroatoms, e.g., N, O or S, and are called sometimes in this case “heteroaryl” group; these heteroaromatic rings may be fused to other aromatic systems. Such heteroaromatic rings include, but are not limited to furanyl, thienyl, pyrrolyl, pyrazolyl, imidazolyl, triazolyl, isoxazolyl, oxazolyl, thiazolyl, isothiazolyl, pyridyl, pyridazyl, pyrimidyl, pyrazinyl and triazinyl ring structures. The aryl or heteroaryl substituents may be unsubstituted or substituted with one or more substituents selected from but not limited to halogen, hydroxy, C₁-C₆ alkoxy, sulfo, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied.

### The Polyester Composition

The polyester compositions described herein include a semi-aromatic, semi-crystalline polyester, a polyolefin and a low Dₖ/D_{f} glass fiber. In some embodiments, the polyester composition can include additional components. As noted above, it was surprisingly discovered that when the polyester weight ratio was from 70% to 95%, the polyester composition had an excellent balance of dielectric properties and mechanical properties. The polyester weight ratio is given by the following formula:

$$100 \times \frac{{W}_{PE}}{{W}_{PE} + {W}_{PO}} ,$$

where W_{PE} and W_{PO} are, respectively, the weights of the semi-aromatic, semi-crystalline polyester and polyolefin in the polyester composition. In some embodiments, the polyester weight ratio is at least 75%, at least 80% or at least 85%. In some embodiments, the polyester weight ratio is no more than 93%. In some embodiments, the polyester weight ratio is from 75% to 95%, or from 80% to 95%, or from 85% to 95%, or from 75% to 93%, or from 80% to 93% or or from 85% to 93%.

Also as mentioned above, it was also surprisingly found that when polyester composition further included high Dₖ/D_{f} glass fibers, the balance of dielectric and mechanical properties was still further improved when the polyester weight ratio was from 75% to 93%. In some embodiments, in which the polyester composition includes additional, high Dₖ/D_{f} glass fiber, the polyester composition has a polyester weight ratio of at least 75%, or at least 77%, or at least 80%, or at least 82%. In some embodiments, in which the polyester composition includes additional, high Dₖ/D_{f} glass fiber, the polyester composition has a polyester weight ratio of no more than 93% or no more than 90%. In some embodiments, in which the polyester composition includes additional, high Dₖ/D_{f} glass fiber, the polyester composition has a polyester weight ratio of from 75% to 93%, or from 77% to 93%, or from 80% to 93%, or from 82% to 93%, or from 75% to 90%, or from 77% to 90%, or from 80% to 90%, or from 82% to 90%.

With respect to dielectric performance, in some embodiments, the polyester composition has a Dₖ, at 1 kHz, of no more than 3.5, or no more than 3.4. In some embodiments, the polyester composition has a Dₖ of at least 2.8, or at least 2.9, or at least 3.0. In some embodiments, the polyester composition has a Dₖ, at 1 kHz of from 2.8 to 3.5, or from 2.9 to 3.5, or from 3.0 to 3.5, or from 2.8 to 3.4, or from 2.9 to 3.4, or from 3.0 to 3.4. In some embodiments, the polyester composition has a Dₖ, at 1 MHz, of no more than 3.4, or no more than 3.3. In some embodiments, the polyester composition has a Dₖ, at 1 MHz, of at least 2.8, or at least 2.9, or at least 3.0. In some embodiments, the polyester composition has a Dₖ, at 1 MHz, of from 2.8 to 3.4, or from 2.9 to 3.4, or from 3.0 to 3.4, or from 2.8 to 3.3, or from 2.9 to 3.3, or from 3.0 to 3.3. In some embodiments, the polyester composition has a Dₖ at both 1 kHz and 1 MHz within the respective ranges described above. Dₖ at 1 kHz and 1 MHz can be measured according to ASTM D150.

In some embodiments, the polyester composition has a D_{f}, at 1 kHz, of no more than 0.003 or no more than 0.002. In some embodiments, the polyester composition has a D_{f}, at 1 kHz of at least 0.0005, or at least 0.001, or at least 0.0014. In some embodiments, the polyester composition has a D_{f}, at 1 kHz, of from 0.0005 to 0.003, or from 0.001 to 0.003, or from 0.0014 to 0.003, or from 0.0005 to 0.002, or from 0.001 to 0.002, or from 0.0014 to 0.002. In some embodiments, the polyester composition has a D_{f}, at 1 MHz, of no more than 0.03, or no more than 0.02. In some embodiments, the polyester composition has a D_{f}, at 1 MHz, at least 0.001 or at least 0.005. In some embodiments, the polyester composition has a D_{f}, at 1 MHz, of from 0.001 to 0.03, or from 0.005 to 0.03, or from 0.001 to 0.02, or from 0.005 to 0.02. In some embodiments, the polyester composition has a D_{f} at both 1 kHz and 1 MHz within the respective ranges described above. D_{f} at 1 kHz and 1 MHz can be measured according to ASTM D150.

In some embodiments, the polyester composition has a Dₖ, at 1.77 GHz, of no more than 3.5, or no more than 3.3, or no more than 3.25. In some embodiments, the polyester composition has a Dₖ, at 1.77 GHz, of no less than 2.7, or no less than 2.8, or no less than 2.9. In some embodiments, the polyester composition has a Dₖ, at 1.77 GHz, of from 2.7 to 3.5, or from 2.7 to 3.3, or from 2.7 to 3.25, or from 2.8 to 3.5, or from 2.8 to 3.3, or from 2.9 to 3.3, or from 2.9 to 3.5, or from 2.9 to 3.3, or from 2.9 to 3.25. In some embodiments, the polyester composition has a D_{f}, at 1.77 GHz, of no more than 0.008, or no more than 0.007, or no more than 0.065. In some embodiments, the polyester composition has a D_{f}, at 1.77 GHz, of no less than 0.003, or no less than 0.004, or no less than 0.0045. In some embodiments, the polyester compositions has a D_{f}, at 1.77 GHz, of from 0.003 to 0.008, or from 0.004 to 0.008, or from 0.0045 to 0.008, or from 0.003 to 0.007, or from 0.004 to 0.007, or from 0.0045 to 0.007, or from 0.003 to 0.0065, or from 0.004 to 0.0065, or from 0.0045 to 0.0065. Dₖ and D_{f} at 1.77 GHz can be measured according to ASTM D2520.

In some embodiments, the polyester composition has a Dₖ, at 2.45 GHz, of no more than 3.3, or no more than 3.2, or no more than 3.1. In some embodiments, the polyester compositions has a Dₖ, at 2.4 GHz, of no less than 2.6, or no less than 2.7, or no less than 2.8. In some embodiments, the polyester composition has a Dₖ, at 2.45 GHz, or of from 2.6 to 3.3, or from 2.7 to 3.3, or from 2.8 to 3.3, or from 2.6 to 3.2, or from 2.7 to 3.2, or from 2.8 to 3.3, or from 2.6 to 3.1, or from 2.7 to 3.1, or from 2.8 to 3.1. In some embodiments, the polyester composition has a D_{f}, at 2.45 GHz, of no more than 0.008, or no more than 0.007, or no more than 0.006. In some embodiments, the polyester composition has a D_{f}, at 2.45 GHz, of no less than 0.003, or no less than 0.004, or no less than 0.0045. In some embodiments, the polyester composition has a D_{f}, at 2.45 GHz, of from 0.003 to 0.008, or from 0.004 to 0.008, or from 0.0045 to 0.008, or from 0.003 to 0.007, or from 0.004 to 0.007, or from 0.0045 to 0.007, or from 0.003 to 0.006, or from 0.004 to 0.006, or from 0.0045 to 0.006. Dₖ and D_{f} at 2.45 GHz can be measured according to ASTM D2520.

With respect to mechanical performance, in some embodiments, the polyester composition has a notched impact strength of at least 80 J/m, or at least 90 J/m, or at least 100 J/m, or at least 110 J/m. In some embodiments, the polyester composition has a notched impact strength of no more than 140 J/m, or no more than 130 J/m, or no more than 120 J/m, or no more than 115 J/m. In some embodiments, the polyester composition has a notched impact strength of from 80 J/m to 140 J/m, or from 90 J/m to 140 J/m, or from 100 J/m to 140 J/m, or from 110 J/m to 140 J/m, or from 80 J/m to 130 J/m, or from 90 J/m to 130 J/m, or from 100 J/m to 130 J/m, or from 110 J/m to 130 J/m, or from 80 J/m to 120 J/m, or from 90 J/m to 120 J/m, or from 100 J/m to 120 J/m, or from 110 J/m to 120 J/m, or from 80 J/m to 115 J/m, or from 90 J/m to 115 J/m, or from 100 J/m to 115 J/m, or from 110 J/m to 115 J/m, Notched impact strength can be measured according to ASTM D256.

In some embodiments, the total concentration of the semi-aromatic, semi-crystalline polyester and the polyolefin in the polyester composition is at least 55 weight percent (“wt. %”), or at least 60 wt. %, or at least 65 wt. %, based on the total weight of the polyester composition. In some embodiments, the total concentration of the semi-aromatic, semi-crystalline polyester and the polyolefin in the polyester composition is no more than 85 wt. %, or no more than 80 wt. %, or no more than 75 wt. %. In some embodiments, the total concentration of the semi-aromatic, semi-crystalline polyester and the polyolefin in the polyester composition is from 55 wt. % to 85 wt. %, or from 55 wt. % to 80 wt. %, or from 55 wt. % to 75 wt. %, or from 60 wt. % to 85 wt. %, or from 60 wt. % to 80 wt. %, or from 60 wt. % to 75 wt. %, or from 65 wt. % to 85 wt. %, or from 65 wt. % to 80 wt. %, or from 65 wt. % to 75 wt. %. As used herein, wt. % is relative to the total weight of the polyester composition, unless explicitly noted otherwise.

In some embodiments, the polyester composition consists essentially of the semi-aromatic, semi-crystalline polyester, the polyolefin and the low Dₖ/D_{f} glass fiber (or a blend of the low Dₖ/D_{f} glass fiber and a high Dₖ/D_{f} glass fiber). In such embodiments, the total concentration of the aforementioned components is at least 95 wt. %, or at least 97 wt. %, or at least 98 wt. %, or at least 99 wt. %, or at least 99.5 wt. %, or at least 99.9 wt. %, based on the total weight of the polyester composition. In some embodiments, the polyester composition includes one or more additional semi-aromatic, semi-crystalline polyester or one or more additional polyolefins. In some such embodiments, each additional semi-aromatic, semi-crystalline polyester and each additional polyolefin is distinct and as described below. In one such embodiment, the polyester compositions consists essentially of the semi-aromatic, semi-crystalline polyesters and one or more additional semi-aromatic, semi-crystalline polyesters; the polyolefin and the one or more additional polyolefins; and the low Dₖ/D_{f} glass fiber (or a blend of the low Dₖ/D_{f} glass fiber and a high Dₖ/D_{f} glass fiber). That is, in such an embodiments, to total concentration of semi-aromatic, semi-crystalline polyesters, polyolefins and the low Dₖ/D_{f} glass fiber (or a blend of the low Dₖ/D_{f} glass fiber and a high Dₖ/D_{f} glass fiber) is at least 95 wt. %, or at least 97 wt. %, or at least 98 wt. %, or at least 99 wt. %, or at least 99.5 wt. %, or at least 99.9 wt. %.

### The Semi-Aromatic, Semi-Crystalline Polyester

The polyester compositions includes a semi-aromatic, semi-crystalline polyester. As used herein, a “semi-aromatic” polyester refers to any polymer including at least 50 mol % of a recurring unit R_{PE} having at least one ester group (—C(O)O—) and at least one aryl group. Additionally as used herein, a “semi-crystalline” polyester (or a “semi-crystalline” polymer) is a polyester (or polymer) that has a heat of fusion (“ΔH_{f}”) of at least 5 joules per gram (“J/g”) at a heating rate of 20° C./min (an amorphous polyester (or polymer) has a ΔH_{f} of less than 5 J/g at a heating rate of 20° C./min). ΔH_{f} can be measured according to ASTM D3418. In some embodiments, the semi-aromatic, semi-crystalline polyester comprises at least 60 mol %, or at least 70 mol % or at least 80 mol %, or at least 90 mol %, or at least 95 mol %, or at least 99 mol %, or at least 99.9 mol % of recurring unit R_{PE}. As used herein, mol % is relative to the total number of recurring units in the indicated polymer (e.g., the semi-aromatic, semi-crystalline polyester), unless explicitly stated otherwise.

In some embodiments, recurring unit R_{PE} is represented by the following formula:

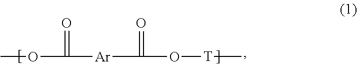

where T is a C₁-C₁₈ alkyl and Ar is an aryl. Preferably, Ar is a phenyl or napthyl. More preferably, Ar is a phenyl and the explicit —COOH groups in formulae (1) to (3) are disposed in the meta position (1,4-) about Ar. In some embodiments, R_{PE} is represented by either one of the following formulae:

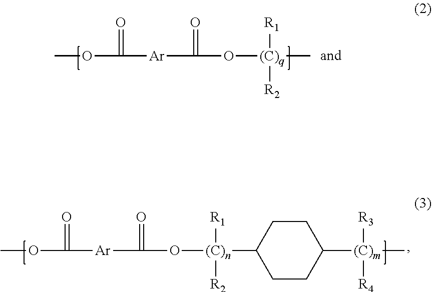

wherein R₁ to R₄, at each location, are independently selected from the group consisting of a hydrogen and a C₁-C₁₂ alkyl, and q, n and m are independently selected integers from 1 to 12. In some embodiments, R₁ to R₄ are all hydrogen. In some embodiments, q is an integer from 3 to 10, preferably from 3 to 5, most preferably either 3 or 4. In some embodiments, n=m. Preferably, n and m are 1.

In some embodiments, the semi-aromatic, semi-crystalline polyester is selected from the group consisting of polycyclohexylenedimethylene terephthalate (“PCT”), polyethylene terephthalate (“PET”), polybutylene terephthalate (“PBT”), polyethylene naphthalate (“PEN”) and polybutylene naphthalate (“PBN”). Preferably, the semi-aromatic, semi-crystalline polyesters is PBT or PEN.

Of course, in some embodiments, the semi-aromatic, semi-crystalline polyester has additional recurring units distinct from R_{PE}. In some such embodiments, the semi-aromatic, semi-crystalline polyester has one or more additional recurring units R*_{PE}, each distinct from each other and from R_{PE}. In one such embodiment, each recurring unit R*_{PE} is represented by a formula selected from the group of formulae consisting of formulae (1) to (3). In some embodiments, the total concentration of recurring unit R_{PE} and one or more additional recurring units R*_{PE} is at least 60 mol %, or at least 70 mol %, or at least 80 mol %, or at least 90 mol %, or at least 95 mol %, or at least 99 mol %, or at least 99.5 mol %, or 100 mol %, relative to the total number of recurring units in the semi-aromatic, semi-crystalline polyester.

In some embodiments, the semi-aromatic, semi-crystalline polyester has an intrinsic viscosity of from about 0.4 to about 2.0 deciliters/gram (“dl/g”) as measured in a 60:40 phenol/tetrachloroethane mixture or similar solvent at about 30° C. Preferably, the semi-aromatic, semi-crystalline polyester has an intrinsic viscosity of 0.5 to 1.4 dl/g. Intrinsic viscosity can be measured according to ASTM D 5225.

In some embodiments, the semi-aromatic, semi-crystalline polyester has a number average molecular weight (“Mn”) of at least about 1,000 g/mol, or at least about 5,000 g/mol, or at least about 10,000 g/mol. In some embodiments, the semi-aromatic, semi-crystalline polyester has a Mn of no more than about 100,000 g/mol, or no more than about 75,000 g/mol, or no more than about 50,000 g/mol. In some embodiments, the semi-aromatic, semi-crystalline polyester has a Mn of from 1,000 g/mol to 50,000 g/mol, or from 5,000 g/mol to 75,000 g/mol, or from 10,000 g/mol to 50,000 g/mol. In some embodiments, the semi-aromatic, semi-crystalline polyester has a weight average molecular weight (“Mw”) of at least about 1,000 g/mol, or at least about 15,000 g/mol, or at least about 20,000 g/mol. In some embodiments, the semi-aromatic, semi-crystalline polyester has a Mw of no more than about 200,000 g/mol, or no more than about 150,000 g/mol, or no more than about 125,000 g/mol, or no more than about 110,000 g/mol, or no more than about 100,000 g/mol. In some embodiments, the semi-aromatic, semi-crystalline polyester has a Mw of from 1,000 g/mol to 200,000 g/mol, or from 15,000 g/mol to 200,000 g/mol, or from 20,000 g/mol to 200,000 g/mol, or from 20,000 g/mol to 150,000 g/mol, or from 20,000 g/mol to 125,000 g/mol, or from 20,000 g/mol to 110,000 g/mol, or from 20,000 g/mol to 100,000 g/mol. Mn and Mw can be determined by gel permeation chromatography (GPC) using ASTM D5296 with polystyrene standards.

In some embodiments, the semi-aromatic, semi-crystalline polyester has a Tm of at least 210° C., preferably at least 220° C., more preferably at least 230° C. and most preferably at least 240° C. In some embodiments, the semi-aromatic, semi-crystalline polyester has a Tm of at most 350° C., preferably at most 340° C., more preferably at most 330° C. and most preferably at most 320° C. In some embodiments, the semi-aromatic, semi-crystalline polyester has a Tm of from 210° C. to 350° C., or from 220° C. to 340° C., or from 230° C. to 330° C., or from 240° C. to 320° C. In some embodiments, the semi-aromatic, semi-crystalline polyester has a glass transition temperature (“Tg”) of at least 60° C., or at least 70° C., or at least 80° C. In some embodiments, the semi-aromatic, semi-crystalline polyester has a Tg of no more than 180° C., or no more than 160° C., or no more than 140° C. In some embodiments, the semi-aromatic, semi-crystalline polyester has a Tg of from 60° C. to 180° C., or from 70° C. to 160° C., or from 80° C. to 140° C.

In some embodiments, the concentration of the semi-aromatic, semi-crystalline polyester in the polyester composition is at least 30 wt. %, or at least 35 wt. %, or at least 40 wt. %, or at least 45 wt. %, based on the total weight of the polyester composition. In some embodiments, the concentration of the semi-aromatic, semi-semi-crystalline polyester in the polyester compositions is no more than 80 wt. %, or no more than 75 wt. %, or no more than 70 wt. %, or no more than 65 wt. %. In some embodiments, the concentration of the semi-aromatic, semi-crystalline polyester in the polyester composition is from 30 wt. % to 80 wt. %, or from 40 wt. % to 75 wt. %, or from 45 wt. % to 70 wt. %, or from 45 wt. % to 65 wt. %.

In some embodiments, the polyester composition includes one or more additional semi-aromatic, semi-crystalline polyesters, each distinct from each other and from the semi-aromatic, semi-crystalline polyesters. In some such embodiments, the total concentration of semi-aromatic, semi-crystalline polyesters is within the ranges given above for the semi-aromatic, semi-crystalline polyester. In alternative embodiments, the concentration of each semi-aromatic, semi-crystalline polyester is within the ranges given above for the semi-aromatic, semi-crystalline polyester.

### The Polyolefin

The polyester composition includes a polyolefin having a recurring unit a recurring unit R_{PO}, including at least 4 carbon atoms and represented by the following formula:

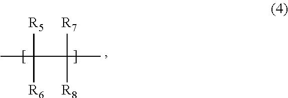

where R₅ to R₈ are independently selected from the group consisting of a hydrogen and a C₁-C₁₀ alkyl group. Preferably, recurring unit (R_{PO}) includes at least 5 carbon atoms. In some embodiments, the polyolefin comprises at least 50 mol %, or at least 60 mol %, or at least 70 mol %, or at least 80 mol %, or at least 90 mol %, or at least 95 mol %, or at least 99 mol %, or at least 99.5 mol % of recurring unit (R_{PO}), the mol % being relative to the total number of recurring units in the polyolefin. In some embodiments, R₆ to R₈ are all hydrogen. Of course, in such embodiments, R₅ is a C₅-C₁₀ alkyl group.

Of course, in some embodiments, the polyolefin has additional recurring units distinct from (R_{PO}). In some such embodiments, the polyolefin has one or more additional recurring units R*_{PO}, each distinct from each other and from (R_{PO}). In one such embodiment, each recurring unit R*_{PO} is represented by a formula (4).

In some embodiments, the polyolefin is selected from the group consisting of poly(4-methyl-1-pentene) (also referred to as polymethylpentene), poly(1-butene), poly(1-pentene), poly(1-hexene), and a mixture of any two or more thereof. Preferably, the polyolefin is poly(4-methyl-1-pentene).

In some embodiments, the polyolefin has a number average molecular weight of less than 1,000,000 g/mol, preferably less than 500,000 g/mol, most preferably less than 200,000 g/mol. In some embodiments, the polyolefin has a weight average molecular weight of less than 2,000,000 g/mol, preferably less than 1,000,00 g/mol, most preferably less than 300,000 g/mol. The number average molecular weight can be measured according to ASTM D5296.

In some embodiments, the polyolefin has a melt flow rate (“MFR”) at 2.16 Kg at 260 ° C. of from 5 g/10 min. to 250 g/10 min., or from 10 g/10 min. to 200 g/10 min., or from 15 g/10 min. to 150 g/10 min., or from 20 g/10 min. to 100 g/10 min., or from 25 g/10 min. to 50 g/10 min., or from 30 g/10 min. to 40 g/10 min. In some embodiments, the polyolefin has an MFR of at least 3 g/10 min. at 250° C. at 2.16 Kg, or 5 Kg. MFR can be measured according to ASTM D1238. In some embodiments, the polyolefin has a viscous melt flow at 30° C. to 70° C. above its melting point. The polyolefin has a uniform and continuous melt above its melt temperature. The polyolefin can be processed by injection molding at 30 to 80 ° C. above its melt temperature.

In some embodiments, the polyolefin has a melting temperature (“Tm”) of at least 170° C., or at least 180° C., or at least 190° C., or at least 200° C., or at least 210° C. In some embodiments, the polyolefin has a Tm of no more than 270° C., or no more than 260° C., or no more than 250° C., or no more than 240° C. In some embodiments, the polyolefin has a Tm of from 170° C. to 270° C., or from 180° C. to 260° C., or from 190° C. to 250° C., or from 200° C. to 240° C., or from 210° C. to 240° C. In some embodiments, the polyolefin has a glass transition temperature (“Tg”) of at least 0° C., or at least 10° C., or at least 20° C., or at least 30° C., or at least 35° C., or at least 40° C. In some embodiments, the polyolefin has a Tg of no more than 80° C., or no more than 70° C., or no more than 65° C., or no more than 60° C. In some embodiments, the polyolefin has a Tg of rom 0° C. to 80° C., or from 10° C. to 70° C., or from 20° C. to 65° C., or from 30° C. to 60° C., or from 35° C. to 60° C., or from 40° C. to 60° C. Tm and Tg can be measured by Differential Scanning calorimetry (“DSC”) according to ASTM D3418.

In some embodiments, the concentration of the polyolefin in the polyester composition is at least 1 wt. %, or at least 3 wt. %, or at least 4 wt. %, or at least 5 wt. %, based on the total weight of the polyester composition. In some embodiments, the concentration of the polyolefin in the polyester composition is no more than 40 wt. %, or no more than 30 wt. %, or no more than 25 wt. %, or no more than 20 wt. %, based on the total weight of the polyester composition. In some embodiments, the concentration of the polyolefin in the polyester composition is from 1 wt. % to 40 wt. %, or from 3 wt. % to 30 wt. %, or from 4 wt. % to 25 wt. %, or from 5 wt. % to 20 wt. %.

In some embodiments, the polyester composition includes one or more additional polyolefins, each distinct from each other and from the polyolefin. In some such embodiments, the total concentration of polyolefins is within the ranges given above for the polyolefin. In alternative embodiments, the concentration of each polyolefin is within the ranges given above for the polyolefin.

### The Glass Fibers

The polyester composition includes a low Dₖ/D_{f} glass fiber and, in some embodiments, additional glass fiber that is high Dₖ/D_{f} glass fibers. In general, with respect to composition, glass fibers are silica-based glass compounds that contain several metal oxides which can be tailored to create different types of glass. The main oxide is silica in the form of silica sand; the other oxides such as calcium, sodium and aluminum are incorporated to reduce the melting temperature and impede crystallization. The glass fibers can be added as endless fibers or as chopped glass fibers. The glass fibers have generally an equivalent diameter of from 5 to 20 μm, preferably of from 5 to 15 μm, more preferably of from 5 to 10 μm. All glass fiber types, such as A, C, D, E, M, R, S, T glass fibers (as described in chapter 5.2.3, pages 43-48 of Additives for Plastics Handbook, 2nd ed, John Murphy) and any mixture thereof may be used.

E, R, S and T glass fibers are well known in the art. They are notably described in Fiberglass and Glass Technology, Wallenberger, Frederick T.; Bingham, Paul A. (Eds.), 2010, XIV, chapter 5, pages 197-225. R, S and T glass fibers are composed essentially of oxides of silicon, aluminium and magnesium. In particular, these glass fibers comprise typically from 62-75 wt. % of SiO2, from 16-28 wt. % of Al2O3 and from 5-14 wt. % of MgO. On the other hand, R, S and T glass fibers comprise less than 10 wt. % of CaO.

In some embodiments, the glass fiber (whether low Dₖ/D_{f} glass fiber or high Dₖ/D_{f} glass fiber) is a high modulus glass fiber. High modulus glass fibers have an elastic modulus of at least 76 GPa, preferably of at least 78 GPa, more preferably of at least 80 GPa, and most preferably of at least 82 GPa, as measured according to ASTM D2343. Examples of high modulus glass fibers include, but are not limited to, S, R, and T glass fibers. For example, commercially available high modulus glass fibers are S-1 and S-2 glass fibers from Taishan and AGY, respectively. In some embodiments, the glass fiber is a high modulus and low Dₖ/D_{f} glass fiber.

The morphology of the glass fiber (whether low Dₖ/D_{f} glass fiber or high Dₖ/D_{f} glass fiber) is not particularly limited. The glass fiber can have a circular cross-section (“round glass fiber”) or a non-circular cross-section (“flat glass fiber”). The cross-section is taken in a plane perpendicular to the length of the glass fiber. A non-circular cross-section has a major dimension, which corresponds to the longest dimension in the cross section, and a minor dimension, which is perpendicular to both the major dimension and the length of the glass fiber. The non-circular cross section can be, but is not limited to, oval, elliptical or rectangular.

In some embodiments wherein the glass fiber is a flat glass fiber, the major dimension of the non-circular cross-section is preferably at least 15 μm, more preferably at least 20 μm, even more preferably at least 22 μm, most preferably at least 25 μm, and/or is preferably at most 40 μm, more preferably at most 35 μm, even more preferably at most 32 μm, most preferably at most 30 μm. In some embodiments, the major dimension of the non-circular cross-section ranges from 15 to 35 μm, preferably from 20 to 30 μm, more preferably from 25 to 29 μm. In some embodiments wherein the glass fiber is a flat glass fiber, the minor dimension of the non-circular cross-section is preferably at least 4 μm, more preferably at least 5 μm, even more preferably at least 6 μm, most preferably at least 7 μm, and/or is preferably at most 25 μm, more preferably at most 20 μm, even more preferably at most 17 μm, most preferably at most 15 μm. In some embodiments, the minor dimension of the non-circular cross-section ranges from 5 to 20, preferably from 5 to 15 μm, more preferably from 7 to 11 μm. In some embodiments wherein the glass fiber is flat glass fiber, said flat glass fiber has an aspect ratio preferably of at least 2, more preferably of at least 2.2, even more preferably of at least 2.4, most preferably of least 3, and/or preferably of at most 8, more preferably of at most 6, even more preferably of at most 4. In some embodiments, said flat glass fiber has an aspect ratio ranging from 2 to 6, preferably from 2.2 to 4. The aspect ratio is defined as a ratio of the major dimension of the cross-section of the flat glass fiber to the minor dimension of the same cross-section. The aspect ratio can be measured according to ISO 1888.

In some embodiments wherein the glass fiber is a round glass fiber, said round glass fiber has an aspect ratio which is preferably less than 2, more preferably less than 1.5, even more preferably less than 1.2, still more preferably less than 1.1, most preferably less than 1.05. Of course, the person of ordinary skill in the art will understand that regardless of the morphology of the glass fiber (e.g., round or flat), the aspect ratio cannot, by definition, be less than 1.

The low Dₖ/D_{f} glass fibers in the polyester composition have a Dₖ, at 1 MHz, of no more than 5.5, or no more than 5.4, or no more than 5.3, or no more than 5.2, or no more than 5.1, or no more than 5.0. Additionally, in some embodiments, the low Dₖ/D_{f} glass fibers have a Dₖ, at 1 MHz of at least 3.7, or at least 3.8, or at least 3.9, or at least 4.0. In some embodiments, the low Dₖ/D_{f} glass fibers have a Dₖ, at 1 MHz, of from 3.7 to 5.5, or from 3.7 to 5.4, or from 3.7 to 5.3, or from 3.7 to 5.2, or from 3.7 to 5.1, or from 3.7 to 5.0, or from 3.8 to 5.0, or from 3.9 to 5.0, or from 4.0 to 5.0. The low Dₖ/D_{f} glass fibers also have a D_{f}, at 1 MHz, of no more than 0.002 or no more than 0.001. Additionally, in some embodiments, the low Dₖ/D_{f} glass fibers have a D_{f} of no less than 0.0001 or no less than 0.0005. In some embodiments, the low Dₖ/D_{f} glass fibers have a D_{f} of from 0.0001 to 0.002 or from 0.0005 to 0.001. Dₖ and D_{f} at 1 MHz can be measured according to ASTM D150.

In some embodiments, the concentration of the low Dₖ/D_{f} glass fiber in the polyester composition is at least 10 wt. %, or at least 15 wt. %, or at least 20 wt. %, or at least 25 wt. %, based on the total weight of the polyester composition. Additionally or alternatively, in some embodiments, the concentration of the low Dₖ/D_{f} glass fiber in the polyester composition is no more than 60 wt. %, or no more than 50 wt. %, or no more than 45 wt. %, or no more than 40 wt. %, or no more than 35 wt. %, based on the total weight of the polyester composition. In some embodiments, the concentration of the low Dₖ/D_{f} glass fiber in the polyester composition is from 10 wt. % to 60 wt. %, or from 15 wt. % to 50 wt. %, or from 15 wt. % to 45 wt. %, or from 15 wt. % to 40 wt. %, or from 20 wt. % to 40 wt. %, or from 20 wt. % to 35 wt. %.

As noted above, in some embodiments, the polyester composition includes additional, high Dₖ/D_{f} glass fibers. High Dₖ/D_{f} glass fibers have a Dₖ, at 1 MHz, of more than 5.0, or more than 5.1, or more than 5.2, or more than 5.3, or more than 5.4, and a D_{f}, at 1 MHz, of more than 0.001 or more than 0.002. In some embodiments, in which the polyester composition includes high Dₖ/D_{f} glass fibers, the concentration of the high Dₖ/D_{f} glass fibers in the polyester composition is at least 0.4 wt. %, or at least 0.5 wt. %, or at least 1 wt. %, or at least 2 wt. %, based on the total weight of the polyester composition. In some embodiments, the concentration of the high Dₖ/D_{f} glass fibers in the polyester composition is no more than 10 wt. %, or no more than 5 wt. %, or no more than 4 wt. %. In some embodiments, the concentration of the high Dₖ/D_{f} glass fibers in the polyester composition is from 0.4 wt. % to 10 wt. %, or from 0.5 wt. % to 10 wt. %, or from 1 wt. % to 10 wt. %, or from 2 wt. % to 10 wt. %, or from 0.4 wt. % to 5 wt. %, or from 0.5 wt. % to 5 wt. %, or from 1 wt. % to 5 wt. %, or from 2 wt. % to 5 wt. %, or from 0.4 wt. % to 4 wt. %, or from 0.5 wt. % to 4 wt. %, or from 1 wt. % to 4 wt. %, or from 2 wt. % to 4 wt. %.

In some embodiments in which the polyester compositions includes a low Dₖ/D_{f} glass fiber and a high Dₖ/D_{f} glass fiber, the total concentration of glass fibers in the polyester composition is within the ranges give above with respect to the low Dₖ/D_{f} glass fiber. In some embodiments, the total concentration of each of the the low Dₖ/D_{f} glass fiber and the high Dₖ/D_{f} glass fiber is independently in the range given above with respect to the low Dₖ/D_{f} glass fiber.

### Additional Components

As noted above, in some embodiments, the polyester composition can include additional components, aside from the semi-aromatic, semi-crystalline polyester, the polyolefin, the low Dₖ/D_{f} glass fiber and the high Dₖ/D_{f} glass fiber. In some embodiments, each additional component can be selected from the group consisting of reinforcing agents, tougheners, plasticizers, colorants, pigments, antistatic agents, dyes, lubricants, thermal stabilizers, light stabilizers, flame retardants, nucleating agents and antioxidants.

With respect to reinforcing agents, as used herein in the additional components, the term does not include glass fibers. The reinforcing agents can be selected from fibrous and particulate reinforcing agents. A fibrous reinforcing agent is considered herein to be a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50. In some embodiments, the fibrous reinforcing agents (e.g., carbon fibers) have an average length of from 3 mm to 50 mm. In some such embodiments, the fibrous reinforcing agents have an average length of from 3 mm to 10 mm, or from 3 mm to 8 mm, or from 3 mm to 6 mm, or from 3 mm to 5 mm. In alternative embodiments, the fibrous reinforcing agents have an average length of from 10 mm to 50 mm, or from 10 mm to 45 mm, or from 10 mm to 35 mm, or from 10 mm to 30 mm, or from 10 mm to 25 mm, or from 15 mm to 25 mm. The average length of the fibrous reinforcing agents can be taken as the average length of the fibrous reinforcing agent prior to incorporation into the polyester composition or can be taken as the average length of the fibrous reinforcing agent in the polyester composition.

In some embodiments, the fibrous reinforcing agent is selected from the group consisting of mineral fillers (such as talc, mica, kaolin, calcium carbonate, calcium silicate, magnesium carbonate), carbon fibers, synthetic polymeric fibers, aramid fibers, aluminum fibers, titanium fibers, magnesium fibers, boron carbide fibers, rock wool fibers, steel fibers and wollastonite.

In some embodiments, the polyester composition is free of hollow reinforcing agents. Hollow reinforcing agents include, but are not limited to, hollow glass fibers and glass bubbles. As used herein, “free of” a component means that the polyester composition has less than 5 wt. %, or less than 2 wt. %, or less than 1 wt. %, or less than 0.1 wt. %, or less than 0.05 wt. %, or less than 0.001 wt. %, or even undetectable concentrations of the named component. In general, hollow reinforcing agents undesirably reduce the mechanical performance (e.g., notched impact strength) of the polyester compositions.

With respect to tougheners, they are generally a low Tg polymer. For example, in some embodiments, the toughener has a Tg below room temperature, or below 0° C., or even below −25° C. As a result of its low Tg, the toughener are typically elastomeric at room temperature. Tougheners can be functionalized polymer backbones.

The polymer backbone of the toughener can be selected from elastomeric backbones comprising polyethylenes and copolymers thereof, e.g., ethylene-butene; ethylene-octene; polypropylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

When the toughener is functionalized, the functionalization of the backbone can result from the copolymerization of monomers which include the functionalization or from the grafting of the polymer backbone with a further component.

Specific examples of functionalized tougheners are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride.

The toughener may be present in the polyester composition in a total amount of greater than 1 wt. %, or greater than 2 wt. %, or greater than 3 wt. %, based on the total weight of the polyester composition. The toughener may be present in the polyester composition in a total amount of less than 30 wt. %, or less than 20 wt. %, or less than 15 wt. %, or less than 10 wt. %, based on the total weight of the polyester composition. In some embodiments, the toughener is present in the polyester composition in a total amount of from 1 wt. % to 30 wt. %, or from 2 wt. % to 20 wt. %, or from 3 wt. % to 15 wt. %. In some embodiments, the polyester composition is free of a toughener.

The polyester composition may also include other conventional additives commonly used in the art, including plasticizers, colorants, pigments (e.g., black pigments such as carbon black and nigrosine), antistatic agents, dyes, lubricants (e.g., linear low density polyethylene, calcium or magnesium stearate or sodium montanate), thermal stabilizers, light stabilizers, flame retardants, nucleating agents and antioxidants.

### Preparation of the Polyester Composition

The polyester composition can be made by methods well known in the art. For example, in some embodiments, the polyester composition can be formed by melt-blending the semi-aromatic, semi-crystalline polyester, the polyolefin, the low Dₖ/D_{f} glass fiber and additional components, as described above.

Any suitable melt-blending method may be used for mixing polymeric ingredients and non-polymeric ingredients. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing agent presents a long physical shape (for example, a long fiber), drawing extrusion molding may be used to prepare a reinforced composition.

### Articles and Applications

Due, at least in part to the excellent balance of dielectric and mechanical properties, the polyester compositions can be desirably incorporated into mobile electronic devices components.

As used herein, a “mobile electronic device” refers to an electronic device that is intended to be conveniently transported and used in various locations. A mobile electronic device can include, but is not limited to, a mobile phone, a personal digital assistant (“PDA”), a laptop computer, a tablet computer, a wearable computing device (e.g., a smart watch, smart glasses and the like), a camera, a portable audio player, a portable radio, global position system receivers, and portable game consoles.

The mobile electronic device component may, for example, comprise a radio antenna and the polyester composition. In this case, the radio antenna can be a WiFi antenna or an RFID antenna. The mobile electronic device component may also be an antenna housing.

In some embodiments, the mobile electronic device component is an antenna housing. In some such embodiments, at least a portion of the radio antenna is disposed on the polyester composition. Additionally or alternatively, at least a portion of the radio antenna can be displaced from the polyester composition. In some embodiments, the mobile electronic device component can be a mounting component with mounting holes or other fastening device, including but not limited to, a snap fit connector between itself and another component of the mobile electronic device, including but not limited to, a circuit board, a microphone, a speaker, a display, a battery, a cover, a housing, an electrical or electronic connector, a hinge, a radio antenna, a switch, or a switchpad. In some embodiments, the mobile electronic device component can be at least a portion of an input device. In some embodiments, the mobile electronic device component can be frame (e.g., mobile phone or tablet frame) or a frame component.

The article can be molded from the polyester composition, by any process adapted to thermoplastics, e.g., extrusion, injection molding, blow molding, rotomolding or compression molding.

The article can be printed from the polyester composition, by a process comprising a step of extrusion of the material, which is for example in the form of a filament, or comprising a step of laser sintering of the material, which is in this case in the form of a powder.

The polyester compositions can also be incorporated into a method for manufacturing a three-dimensional (3D) object with an additive manufacturing system, comprising:
providing a part material comprising the polyester composition, and
printing layers of the three-dimensional object from the part material.

The polyester composition can therefore be in the form of a thread or a filament to be used in a process of 3D printing, e.g., Fused Filament Fabrication, also known as Fused Deposition Modelling (“FDM”).

The polyester composition can also be in the form of a powder, for example a substantially spherical powder, to be used in a process of 3D printing, e.g., Selective Laser Sintering (“SLS”).

### Use of the Polyester Compositions and Articles

The polyester compositions and articles can be used for manufacturing a mobile electronic device component, as described above.

The present invention also relates to the use of the above-described polyester compositions for 3D printing an object.

### EXAMPLES

The examples demonstrate the dielectric performance and mechanical performance of the polyester compositions. In the examples, the following components were used:
Polybutylene terephthalate (“PBT”) (Polyester): PBT in pellet form was purchased from Celanese under the trade name Celanex 1400A®/Celanex 1401A®.
Polyethylene naphthalate (“PEN”) (Polyester): PEN in pellet form was purchased from Indorama®.
Polymethylpentene (“PMP”) (Polyolefin): PMP was obtained from either RTP or Orida™.
Glass Fiber 1 (“GF 1”): Low Dₖ/D_{f} glass fiber, commercially obtained from Chongqing Polycomp International Corp. under the trade name CS(HL)301HP™, and having a Dₖ of less than 5.0 and a D_{f} of less than 0.002, as measured according to ASTM D150 at 1 MHz.
Glass Fiber 2 (“GF 2”): high Dₖ/D_{f} E-glass fiber.
Additives: Nucleating agent Mineral Talc Mistron Vapor R from Mineral and Pigment Solution Southwest, heat stabilizer (Irganox® 1098) from BASF Corporation. Hostanox P-EPQ was purchased from Clariant Corporation. Unless otherwise stated, the additives (Mineral Talc Mistron Vapor R, Irganox® 1098, and Hostanox® P-EPQ®) were used in the following quantities: 0.1 wt. %, 0.2 wt. %, and 0.8 wt. % respectively

### Example 1—Polybutylene Terephthalate

The present example demonstrates the mechanical and dielectric performance of polyester compositions including PBT.

To demonstrate mechanical and dielectric performance, several samples were made. Sample parameters for the examples (“E”) and comparative examples (“CE”) are provided in Tables 1 to 3. Table 1 displays sample parameters and testing results for polyester blends including PBT, PMP and a mixture of glass fiber including low Dₖ/D_{f} glass fiber and high Dₖ/D_{f} E-glass fibers. Table 2 displays sample parameters and testing results for polyester blends including PBT, PMP and low Dₖ/D_{f} glass fiber as the only glass fiber. Table 3 displays sample parameters and testing results for polyester blends including PBT and PMP, the polyester blends being free of glass fiber. In the tables, “PE weight ratio” refers to the polyester weight ratio, as defined above.

Impact properties were measured according to ASTM D256. Measurements made on 10 injection molded ASTM flex bars. Tensile properties were measured according to ASTM D638. Measurements were made on 5 injection molded ASTM tensile bars and were characterized using a 2 mm/minute for the whole test. The ASTM tensile bar had a length of 50.08±1 mm, a width of 12.7±0.2 mm, and a thickness of 3.2±0.4 mm.

Dielectric properties were measured according to ASTM D150 (1 KHz and 1 MHz) or D2520 (1.77 GHz and 2.45 GHz). For dielectric properties measured using ASTM D150, the measurements were performed on a 4.0 mm flat disc with a diameter of 50.8 mm. Measurements of Dₖ and D_{f} at 1 MHz and 1 KHz were taken on injection molded discs having dimensions of 50.8 mm diameter by 4.0 mm thickness. Before testing according to ASTM D150, samples were conditioned following the ASTM D618 procedure. For dielectric properties measured using ASTMD 2520, the measurement was performed on an ASTM flex bar with the following dimensions: 3.2mm×12.7mm×125mm. Measurements of Dₖ and D_{f} at 1.77 GPa and 2.45 GPa were taken on injection rectangular ASTM flex bars. For ASTM D2520, samples were tested as molded.

As noted above, Tables 1 to 3 display testing results.

TABLE 1

| | CE1 | E1 | E2 | E3 | CE2 | CE3 | E4 |
|---|---|---|---|---|---|---|---|
| PBT (wt. %) | 68.9 | 63.9 | 58.9 | 48.9 | 0 | 78.9 | 68.9 |
| PMP (wt. %) | — | 5.5 | 11 | 22 | 68.9 | — | 11 |
| PE weight ratio (%) | 100 | 92.7 | 85.5 | 70.9 | 0 | 100 | 87.3 |
| GF 1 (wt. %) | 30 | 29.5 | 29 | 28 | 30 | 20 | 19 |
| GF 2 (wt. %) | 0 | 0.49 | 0.98 | 1.96 | 0 | 0 | 0.98 |
| Additives (wt. %) | 1.1 | 1.1 | 1.1 | 1.1 | 1.1 | 1.1 | 1.1 |

Impact Properties

| | | | | | | | |
|---|---|---|---|---|---|---|---|
| Notched Impact | 96.7 | 125.2 | 138.2 | 116.8 | 54.2 | 76.6 | 97 |
| (J/m) | | | | | | | |
| Un-Notched Impact | 891 | 941 | 826 | 480 | 205 | 630 | 745 |
| (J/m) | | | | | | | |

Tensile Properties

| | | | | | | | |
|---|---|---|---|---|---|---|---|
| Tensile Modulus | 9.46 | 9.11 | 8.94 | 8.54 | 5.3 | 6.9 | 6.7 |
| (GPa) | | | | | | | |
| Tensile Strength | 138 | 132 | 125 | 98.1 | 46 | 121 | 104 |
| (MPa) | | | | | | | |
| Tensile Strain (%) | 2.6 | 2.5 | 2.4 | 2.2 | 1.4 | 3.0 | 2.8 |

Dielectric Properties

| | | | | | | | |
|---|---|---|---|---|---|---|---|
| Dielectric constant at | 3.46 | 3.36 | 3.26 | 3.09 | 2.38 | 3.37 | 3.17 |
| 1 KHz | | | | | | | |
| Dissipation factor at | 0.0022 | 0.0020 | 0.0019 | 0.0015 | 0.0025 | 0.0018 | 0.0016 |
| 1 KHz | | | | | | | |
| Dielectric constant at | 3.36 | 3.26 | 3.17 | 3.02 | 2.37 | 3.27 | 3.08 |
| 1 MHz | | | | | | | |
| Dissipation factor at | 0.0145 | 0.0134 | 0.0122 | 0.0099 | 0.0006 | 0.016 | 0.013 |
| 1 MHz | | | | | | | |

TABLE 2

| | CE4 | CE5 | E5 | E6 | E7 | CE6 |
|---|---|---|---|---|---|---|
| PBT (wt. %) | 67.9 | 66.9 | 63.9 | 58.9 | 48.9 | 38.9 |
| PMP (wt. %) | 1 | 2 | 5 | 10 | 20 | 30 |
| PE weight ratio (%) | 98.6 | 97.1 | 92.7 | 85.5 | 71.0 | 56.5 |
| GF1 (wt. %) | 30 | 30 | 30 | 30 | 30 | 30 |
| GF2 (wt. %) | — | — | — | — | — | — |
| Additives (wt. %) | 1.1 | 1.1 | 1.1 | 1.1 | 1.1 | 1.1 |

Impact Properties

| | | | | | | |
|---|---|---|---|---|---|---|
| Notched Impact (J/m) | 108.3 | 108.3 | 114.2 | 112 | 102 | 91 |
| Un-Notched Impact (J/m) | 917 | 907 | 875 | 790 | 560 | 406 |

Tensile Properties

| | | | | | | |
|---|---|---|---|---|---|---|
| Tensile Modulus (GPa) | 9.2 | 9.2 | 9.2 | 9.0 | 8.4 | 7.7 |
| Tensile Strength (MPa) | 136 | 130 | 128 | 114 | 95 | 75 |
| Tensile Strain (%) | 2.9 | 2.8 | 2.7 | 2.4 | 2.2 | 1.9 |

Dielectric Properties

| | | | | | | |
|---|---|---|---|---|---|---|
| Dielectric constant at 1.77 | 3.27 | 3.26 | 3.22 | 3.15 | 2.98 | 2.82 |
| GHz | | | | | | |
| Dissipation factor at 1.77 GHz | 0.0065 | 0.0063 | 0.0061 | 0.0057 | 0.0049 | 0.0043 |
| Dielectric constant at 2.45 | 3.15 | 3.14 | 3.10 | 3.04 | 2.89 | 2.74 |
| GHz | | | | | | |
| Dissipation factor at 2.45 GHz | 0.0058 | 0.0057 | 0.0056 | 0.0052 | 0.0045 | 0.0040 |

TABLE 3

| | CE7 | CE8 | CE9 | CE10 | CE11 | CE12 |
|---|---|---|---|---|---|---|
| PBT (wt. %) | 67.9 | 66.9 | 63.9 | 58.9 | 48.9 | 38.9 |
| PMP (wt. %) | 1 | 2 | 5 | 10 | 20 | 30 |
| PE weight ratio (%) | 98.6 | 97.1 | 92.7 | 85.5 | 71.0 | 56.5 |
| GF1 (wt. %) | — | — | — | — | — | — |
| GF2 (wt. %) | — | — | — | — | — | — |
| Additives (wt. %) | 1.1 | 1.1 | 1.1 | 1.1 | 1.1 | 1.1 |

Impact Properties

| | | | | | | |
|---|---|---|---|---|---|---|
| Notched Impact (J/m) | 30.3 | 27.1 | 27.8 | 26.1 | 25.0 | 25.2 |
| Un-Notched Impact (J/m) | 467 | 598 | 459 | 464 | 268 | 212 |

Tensile Properties

| | | | | | | |
|---|---|---|---|---|---|---|
| Tensile Modulus (GPa) | 2.9 | 2.9 | 2.8 | 2.7 | 2.6 | 2.4 |
| Tensile Strength (MPa) | 56.4 | 57.6 | 53.0 | 48.8 | 43.0 | 38.8 |
| Tensile Strain (%) | 11 | 9.7 | 12 | 9.1 | 6.1 | 5.4 |

Dielectric Properties

| | | | | | | |
|---|---|---|---|---|---|---|
| Dielectric constant at 1.77 | 2.92 | 2.92 | 2.87 | 2.81 | 2.70 | 2.60 |
| GHz | | | | | | |
| Dissipation factor at 1.77 | 0.0066 | 0.0065 | 0.0063 | 0.0059 | 0.0054 | 0.0046 |
| GHz | | | | | | |
| Dielectric constant at 2.45 | 2.83 | 2.83 | 2.78 | 2.72 | 2.62 | 2.54 |
| GHz | | | | | | |
| Dissipation factor at 2.45 | 0.0060 | 0.0058 | 0.0056 | 0.0053 | 0.0049 | 0.0042 |
| GHz | | | | | | |

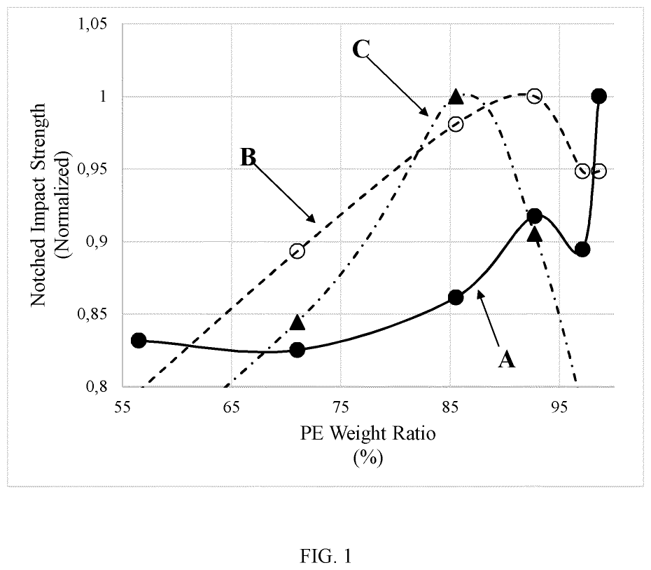

Referring to Tables 1 to 3, samples including glass fibers had significantly different notched-impact behavior as a function of PE weight ratio, relative to samples free of glass fibers. FIG. 1 is a graph showing plots of normalized notched-impact strength as a function of PE weight ratio. The solid line with filled circles (series A) displays normalized notched-impact strength for samples free of glass fibers (Table 3). The dashed line with open circles (series B) displays normalized notched-impact strength for samples including, as glass fibers, only low Dₖ/D_{f} glass fibers (Table 2). The dotted-dashed line with closed triangles (series C) displays normalized notched-impact strength for samples including a mix of low Dₖ/D_{f} and high Dₖ/D_{f} glass fibers (Table 1). For clarity, the normalized values represent the values in each series (each Table) divided by the highest value in each series. Comparison of series B with series A demonstrates that the presence of glass fibers surprisingly and qualitatively radically changed the behavior of the notched-impact performance of the polyester blend. For example, Series A shows significant inflection points around about 70% and 97% PE weight ratio, which are either not present or are significantly smaller magnitude in series B. Similar results are seen when comparing series C with series A. Furthermore, comparison of series C with series B demonstrates the addition of low Dₖ/D_{f} and high Dₖ/D_{f} glass fibers further surprisingly and qualitatively changes the behavior of the notched-impact values as a function of PE weight ratio. Still further, comparison of E4 with CE3 demonstrates that at 20 wt. % GF1, there is surprisingly an increase in both the notched and un-notched impact resistance where the polyester composition includes a blend of PBT and PMP. In all cases the examples (PE weight ratio between 70% and 95%) had an outstanding balance of impact performance and dielectric performance.

### Example 2—Polyethylene Naphthalate

The present example demonstrates the mechanical and dielectric performance of polyester compositions including PEN.

To demonstrate mechanical and dielectric performance, several samples were made. Sample parameters are provided in Table 4.

TABLE 4

| | Tests | CE12 | E8 | E9 | CE2 |
|---|---|---|---|---|---|
| PEN (wt. %) | — | 68.9 | 63.9 | 58.9 | 0 |
| PMP (wt. %) | — | — | 5.5 | 11 | 68.9 |
| PE weight | — | 100 | 92.7 | 85.5 | 0 |
| ratio | | | | | |
| GF1 (wt. %) | — | 30 | 29.5 | 29 | 30 |
| GF2 (wt. %) | | 0 | 0.49 | 0.98 | 0 |
| Additives | — | 1.1 | 1.1 | 1.1 | 1.1 |
| (wt. %) | | | | | |

Impact Properties

| | | | | | |
|---|---|---|---|---|---|
| Notched | ISO 180 | 8.97 | 13 | 13.2 | 5.8 |
| Impact | | | | | |
| (KJ/m²) | | | | | |
| Un-Notched | ISO 180 | 34.7 | 44.2 | 32.5 | 11.1 |
| Impact | | | | | |
| (KJ/m²) | | | | | |

Tensile Properties

| | | | | | |
|---|---|---|---|---|---|
| Tensile | ISO 527 | 8.7 | 8.7 | 8.3 | 5.3 |
| Modulus | | | | | |
| (GPa) | | | | | |
| Tensile | ISO 527 | 154 | 150 | 126 | 46 |
| Strength | | | | | |
| (MPa) | | | | | |
| Tensile | ISO 527 | 2.6 | 2.5 | 2.2 | 1.4 |
| Strain (%) | | | | | |

Dielectric Properties

| | | | | | |
|---|---|---|---|---|---|
| Dielectric | ASTMD150 | 3.60 | 3.562 | 3.31 | 2.38 |
| constant at 1 | | | | | |
| KHz | | | | | |
| Dissipation | ASTMD150 | 0.0064 | 0.00605 | 0.0056 | 0.0025 |
| factor at 1 | | | | | |
| KHz | | | | | |
| Dielectric | ASTMD150 | 3.47 | 3.427 | 3.21 | 2.37 |
| constant at 1 | | | | | |
| MHz | | | | | |
| Dissipation | ASTMD150 | 0.0097 | 0.00928 | 0.0079 | 0.0006 |
| factor at 1 | | | | | |
| MHz | | | | | |

Referring to Table 4, the samples having a PE weight ratio of 92.7% and 85.5% surprisingly had increased notched impact resistance, relative to samples having a PE weight ratio of 100% and 0%. All examples (PE weight ratio of between 70% and 90%) had an excellent balance of impact and dielectric properties. Still further, it is noted that the un-notched impact of E8 was greater than that that of CE1 and E9. Both E8 and E9 had desirable dielectric performance. For clarity, CE2 is reproduced in Table 4 for ease of comparison.

The embodiments above are intended to be illustrative and not limiting. Additional embodiments are within the inventive concepts. In addition, although the present invention is described with reference to particular embodiments, those skilled in the art will recognized that changes can be made in form and detail without departing from the spirit and scope of the invention. Any incorporation by reference of documents above is limited such that no subject matter is incorporated that is contrary to the explicit disclosure herein.

1. A polyester composition comprising:
a semi-aromatic, semi-crystalline polyester;
a polyolefin comprising at least 80 mol % of a recurring unit (R_{PO}) including at least 4 carbons, the mol % being relative to the total number of recurring units in the polyolefin, the recurring unit (R_{PO}) being represented by the following formula: 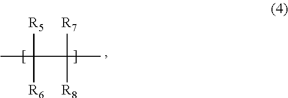
wherein R₅ to R₈ are independently selected from the group consisting of a hydrogen and a C₁-C₁₀ alkyl group;
a glass fiber having, as measured according to ASTM D150 at 1 MHz, a Dₖ of no more than 5.5 and a D_{f} of no more than 0.002; and
a polyester weight ratio of from 70% to 95%;
wherein
the polyester weight ratio is given by the formula:
$$100 \times \frac{{W}_{PE}}{{W}_{PO} + {W}_{PE}} ,$$
and
W_{PE} and W_{PO} are, respectively, the weights of the semi-aromatic, semi-crystalline polyester and the polyolefin in the polyester composition.

2. The polyester composition of claim 1, wherein the semi-aromatic, semi-crystalline polyester comprises a recurring unit R_{PE} that is represented by the following formula: 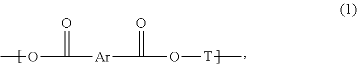
wherein T is a C₁-C₁₈ alkyl and Ar is an aryl.

3. The polyester composition of claim 2, wherein recurring unit R_{PE} is represented by either one of the following formulae: 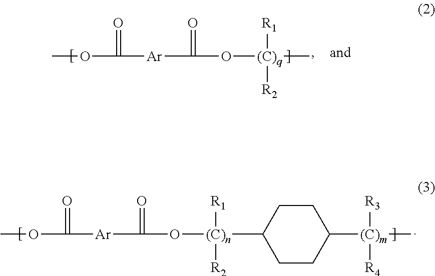
wherein R₁ to R₄, at each location, are independently selected from the group consisting of a hydrogen and a C₁-C₁₂ alkyl, and wherein q, n and m are independently selected integers from 1 to 12.

4. The polyester composition of claim 1, wherein the semi-aromatic, semi-crystalline polyester is selected from the group consisting of polycyclohexylenedimethylene terephthalate, polyethylene terephthalate, polybutylene terephthalate, polyethylene naphthalate and polybutylene naphthalate.

5. The polyester composition of claim 1, wherein R₆ to R₈ are hydrogen.

6. The polyester composition of claim 3, wherein R₃ is a C₃ to C₁₀ alkyl.

7. The polyester composition of claim 1, wherein the polyolefin is selected from the group consisting of poly(4-methyl-1-pentene), poly(1-butene), and poly(1-pentene) and poly(1-hexene).

8. The polyester composition of claim 1, wherein the polyester weight ratio is from 75% to 95%.

9. The polyester composition of claim 1, further comprising a high Dₖ/D_{f} glass fiber.

10. The polyester composition of claim 9, wherein the polyester weight ratio is from 75% to 93%.

11. The polyester composition of claim 1, wherein the polyester composition comprises, as measured according to ASTM D150 at 1 kHz, a Dₖ of no more than 3.5 and a D_{f} of no more than 0.003.

12. The polyester composition of claim 1, wherein the polyester composition comprises, as measured according to ASTM D150 at 1 MHz, a Dₖ of no more than 3.4 and a D_{f} of no more than 0.03.

13. The polyester composition of claim 1, wherein the polyester composition comprises a notched impact strength of at least 80 J/m, as measured according to ASTM D256.

14. A mobile electronic device component comprising the polyester composition of claim 1.

15. The mobile electronic device component of claim 14, wherein the mobile electronic device is selected from the group consisting of a mobile phone, a personal digital assistant, a laptop computer, a tablet computer, a wearable computing device, a camera, a portable audio player, a portable radio, global position system receivers, and portable game consoles.

16. The polyester composition of claim 1, wherein the recurring unit (R_{PO}) of the polyolefin includes at least 5 carbon atoms.

17. The polyester composition of claim 7, wherein the polyolefin is poly(4-methyl-1-pentene).
